(19) United States
(12) Patent Application Publication
(10) Pub. No.: US 2022/0146691 A1
(43) Pub. Date: May 12, 2022

(54) METHODS AND SYSTEMS OF GPS LOCATION POLLING BASED ON USER LOCOMOTIVE ACTIVITY

(71) Applicants: DYLAN JOAO COLAÇO, VASCO (IN); GEET GARG, BANGALORE (IN)

(72) Inventors: DYLAN JOAO COLAÇO, VASCO (IN); GEET GARG, BANGALORE (IN)

(21) Appl. No.: 17/478,955

(22) Filed: Sep. 19, 2021

Related U.S. Application Data
(63) Continuation-in-part of application No. 17/191,685, filed on Mar. 3, 2021, now abandoned.
(60) Provisional application No. 62/984,306, filed on Mar. 3, 2020.
(60) Provisional application No. 62/984,307, filed on Mar. 3, 2020.

(51) Int. Cl. G01S 19/34

(52) U.S. Cl. CPC G01S 19/34

(57) ABSTRACT

A computerized system for global positioning service (GPS) location polling based on user locomotive activity comprising: a mobile device comprising a GPS receiver, a display, a central processing unit (CPU) and a wireless communication transceiver coupled to the GPS receiver, an accelerometer sensor, and a gyroscope sensor, wherein the CPU is programmed to: estimate a position of the GPS receiver based on a location data, detect a motion state of a user of the mobile device based on either an accelerometer sensor data or a gyroscope sensor data, wherein the motion state of the user is set to a not moving state, a walking state, or a driving state.

### CLAIM OF PRIORITY

This Application is a continuation-in-part of and claims priority to U.S. patent application Ser. No. 17/191,685, filed on 3 Mar. 2021. U.S. patent application Ser. No. 17/191,685 is hereby incorporated by reference in its entirety.

U.S. patent application Ser. No. 17/191,685 claims priority to U.S. Provisional Patent Application No. 62/984,306, filed on Mar. 3, 2020. U.S. patent application Ser. No. 17/191,685 claims priority to U.S. Provisional Patent Application No. 62/984,307, filed on Mar. 3, 2020. These provisional applications are hereby incorporated by reference in their entirety.

### FIELD OF INVENTION

This application relates to global positioning systems and more specifically to GPS location polling based on user locomotive activity.

### BACKGROUND

Calculating the user's position is an expensive operation in terms of energy. For example, a polling frequency needs to be selected, based on which the GPS device (Global Positioning System), generally present in a handheld mobile phone, calculates the position of the user on the surface of the earth. In a GPS system, various satellites send out signals that can become attenuated due to the distance the electromagnetic waves travel. The mobile device has to amplify the attenuated signal before they can be used to triangulate the user's position. This process can significantly impact the battery consumption of the mobile device.

Traditionally, a polling frequency of the GPS signal is decided and used to periodically calculate the user's position. A high polling frequency ensures timely updates while the user moves, at the cost of the user's battery life. Selecting a lower polling frequency to conserve battery results in less real-time updates. This can lead to more inaccurate decisions taken by a routing engine, and also an unclear user trail (e.g. it may not be dear which path the user may have taken in some circumstances, etc.). Accordingly, improvement to methods of setting the polling frequency of the GPS signal are desired.

### SUMMARY OF THE INVENTION

A computerized system for global positioning service (GPS) location polling based on user locomotive activity comprising: a mobile device comprising a GPS receiver, a display, a central processing unit (CPU) and a wireless communication transceiver coupled to the GPS receiver, an accelerometer sensor, and a gyroscope sensor, wherein the CPU is programmed to: estimate a position of the GPS receiver based on a location data, detect a motion state of a user of the mobile device based on either an accelerometer sensor data or a gyroscope sensor data, wherein the motion state of the user is set to a not moving state, a walking state, or a driving state.

### BRIEF DESCRIPTION OF THE DRAWINGS

FIG. 1 illustrates an example system for implementing GPS location polling frequency based on user locomotive activity, according to some embodiments.

FIG. 2 is a block diagram of a sample computing environment that can be utilized to implement various embodiments.

FIG. 3 illustrates an example process for GPS location polling frequency based on user locomotive activity, according to some embodiments.

The Figures described above are a representative set and are not an exhaustive with respect to embodying the invention.

### DESCRIPTION

Disclosed are a system, method, and article of GPS Location Polling based on User Locomotive Activity. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ in an embodiment; and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Accelerometer is a device that measures proper acceleration. Acceleration can be the acceleration (e.g. rate of change of velocity) of a body in its own instantaneous rest frame.

Application programming interface (API) can specify how software components of various systems interact with each other.

Cloud computing can involve deploying groups of remote servers and/or software networks that allow centralized data storage and online access to computer services or resources. These groups of remote serves and/or software networks can be a collection of remote computing services.

Global Positioning System (GPS) is a satellite-based radio-navigation system.

Gyroscope is a device used for measuring or maintaining orientation and angular velocity.

### Example Systems

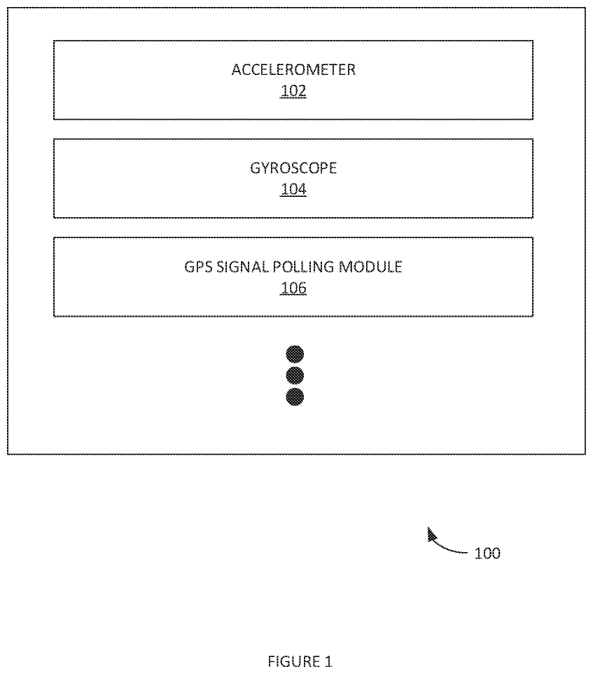

FIG. 1 illustrates an example system 100 for implementing GPS location polling frequency based on user locomotive activity, according to some embodiments. System 100 can be implemented in a mobile device (e.g. user's mobile device, vehicle tracking system, etc.)

System 100 can include accelerometer(s) 102 and gyroscope(s) 104. Accelerometer(s) 102 can measure proper acceleration of system 100. Gyroscope.(s) 104 can measure the orientation and angular velocity of system 100.

System 100 include GPS signal polling module 106. GPS signal polling module 106 can read data from the accelerometer and gyroscope. GPS signal polling module 106 can determine if the user's locomotion state has changed. GPS signal polling module 106 can, when the users locomotion state has changed, set the GPS polling frequency based on the current user's locomotion state. GPS signal polling module 106 can implement process 300 infra. System 100 can be implemented using and/or integrated into system 200 infra.

System 100 can implement GPS tracking (e.g. with a geo-tracking unit) using the GPS to determine its movement and/or determine a WGS84 UTM geographic position to determine a device's location.

In some example embodiments, system 100 can utilize machine learning techniques (e.g. artificial neural networks, etc.). Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning.

In one example, system 100 can use a neural networks to determine the users current locomotion state based on readings from the accelerometer and gyroscope. Artificial neural networks (ANN) or connectionist systems are computing systems based on a collection of connected units or nodes called artificial neurons. Each connection, like the synapses in a biological brain, can transmit a signal to other neurons. An artificial neuron that receives a signal then processes it and can signal neurons connected to it. In ANN implementations, the “signal” at a connection is a real number, and the output of each neuron is computed by some non-linear function of the sum of its inputs. The connections are called edges. Neurons and edges typically have a weight that adjusts as learning proceeds. The weight increases or decreases the strength of the signal at a connection. Neurons may have a threshold such that a signal is sent only if the aggregate signal crosses that threshold. Typically, neurons are aggregated into layers. Different layers may perform different transformations on their inputs. Signals travel from the first layer (the input layer), to the last layer (the output layer), possibly after traversing the layers multiple times.

System 100 can use electrical signals. The CPU reads values from the sensors, then based on the algorithm determines the polling frequency of the GPS and accordingly sends it signals.

It is noted that system 100 can interact with a route optimization engine running on a backend service. System 100 can obtain real-time user location which assists the routing engine make accurate decisions, while conserving power while the user is not moving or moving slowly by reducing the polling frequency of the GPS.

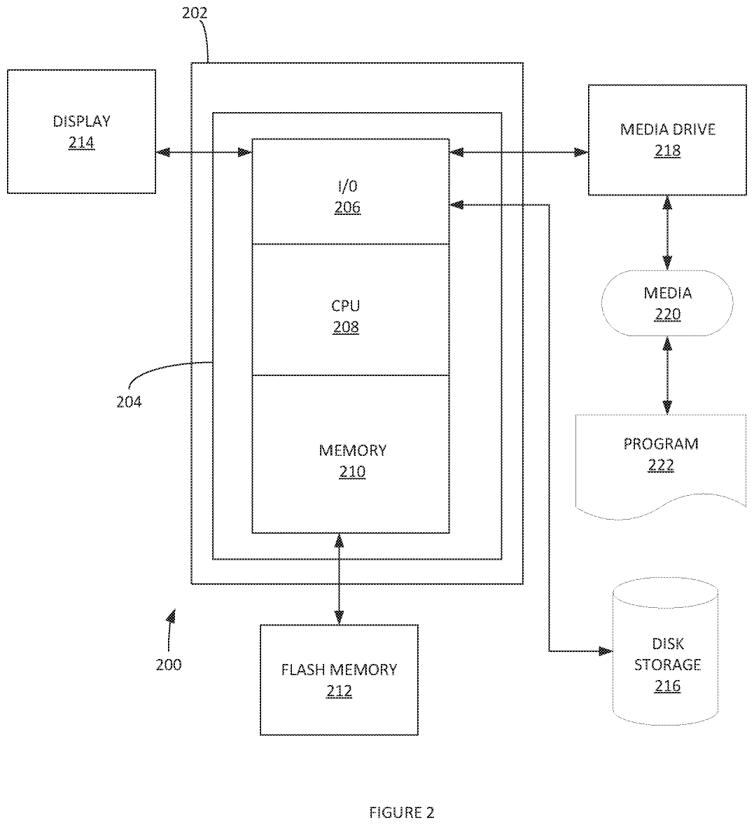

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry or other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. Computing system 200 can communicate with other computing devices based on various computer communication protocols such a Wi-Fi, Bluetooth® (and/or other standards for exchanging data over short distances includes those using short-wavelength radio transmissions), USB, Ethernet, cellular; an ultrasonic local area communication protocol, etc.

### Example Methods

Example methods can use low power sensors (e.g. accelerometer, gyroscope, etc.) to determine the polling frequency of high-power GPS sensor.

Based on measurements from the accelerometer and gyroscope, it is possible to determine whether the user (e.g. a mobile device on a user, etc.) is at rest, walking, or moving in a vehicle. Based on the user's current activity state, the invention changes the GPS sensor's polling frequency. When the user is at rest, a lower polling frequency can be used (e.g. once every five minutes, etc.). When a user is walking, a faster frequency (e.g. once a minute may be used). When the user is travelling in a vehicle, a much faster frequency (e.g. once every ten seconds, etc.) may be used. In this way, the GPS is not polled unnecessarily if it doesn't need to be, while still capturing the users location accurately when it needs to.

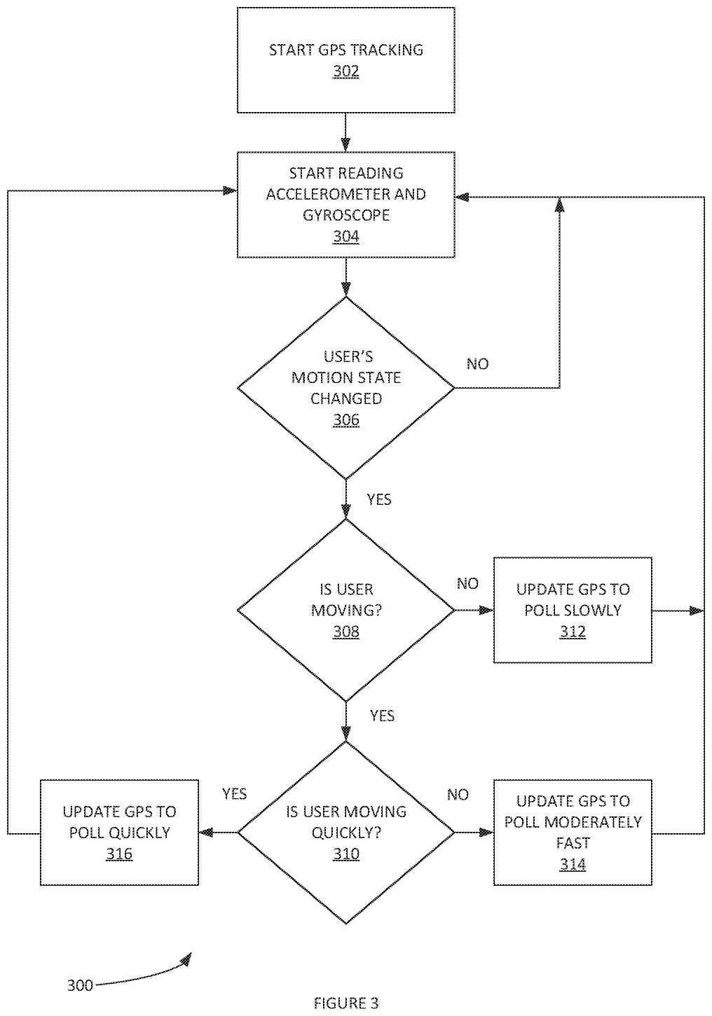

FIG. 3 illustrates an example process 300 for GPS location polling frequency based on user locomotive activity, according to some embodiments. Process 300 can be used to conserved battery life by using less battery intensive sensors on the mobile device (e.g. accelerometer, gyroscope, etc.), As noted supra, an accelerometer measures acceleration or changes in linear movement and a gyroscope measures rotational movement.

More specifically, in step 302, process 300 can start GPS tracking. In step 304, process 300 can start reading accelerometer and gyroscope sensor(s). In step 306, process 300 can determine if the user's motion state changed. For example, the user may have been walking and then begun driving in a vehicle. If ‘yes’, then process 300 can proceed to step 308. If ‘no’ process can return to step 304. In step 308, process 300 can determine if the user moving. If ‘yes’, then process 300 can proceed to step 310. If ‘no’ process can return to step 312. In step 312, process 300 can update GPS to poll slowly and then return to step 304. In step 310, process 300 can determine if the user moving quickly. If ‘yes’, then process 300 can proceed to step 316, if ‘no’ then process 300 can proceed to step 314. In step 314, process 300 can update GPS to poll moderately fast and then return to step 304. In step 316, process 300 can update GPS to poll quickly and then return to step 304. It is noted that process 300 can set ranges for the terms: ‘slowly’, ‘quickly’, etc. For example, these can be analogous to little movement within a building, walking and/or driving a delivery vehicle.

A GPS polling operation can be when a GPS module calculates and reports its position. This can be an update Rate. The update rate of a GPS module can be how often it calculates and reports its position. In one example, when the user's mobile device is detected to be moving at a rate of a driving vehicle (e.g. from 15 mph and higher, etc.) the update rate can be set to 1 Hz, once per second, etc. When the user's mobile device is detected to be in a not moving state, then the update rate can be set to, inter aha: once every five seconds, 500 Hz, etc. When the user's mobile device is detected to be in a walking state (e,g. 3 to 4 mph, etc.), then the update rate can be set to 900 Hz, and the like. These update rates are provided by way of example and not of limitation.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can he appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense, In some embodiments, the machine-readable medium can be a non-transitory form of machine-readable medium.

1. A computerized system for global positioning service (GPS) location polling based on user locomotive activity comprising:
a mobile device comprising a GPS receiver, a display, a central processing unit (CPU) and a wireless communication transceiver coupled to the GPS receiver, an accelerometer sensor, and a gyroscope sensor,
wherein the CPU is programmed to:
estimate a position of the GPS receiver based on a location data,
detect a motion state of a user of the mobile device based on either an accelerometer sensor data or a gyroscope sensor data, wherein the motion state of the user is set to a not moving state, a walking state, or a driving state.

2. The computerized system of c wherein the CPU is programmed to:
decrease a frequency of a GPS polling operation in the mobile device when the motion state of the user is determined to be in a not moving state.

3. The computerized system of claim 1, wherein the CPU is programmed to:
increase the frequency of the GPS polling operation in the mobile device when the motion state of the user is determined to have changed from the not moving state to the walking state or the driving state.

4. The computerized system of claim 1, wherein the CPU is programmed to:
increase the frequency of the GPS polling operation in the mobile device when the motion state of the user is determined to have changed from the walking state to the driving state.

5. The computerized system of claim 1, wherein the CPU is programmed to:
decrease the frequency of the GPS polling operation in the mobile device when the motion state of the user is determined to have changed from the driving state to the walking state.

6. The computerized method of claim 1, wherein the frequency of the GPS polling operation is decreased to conserve a battery life of the mobile device.
